(19) United States
(12) Patent Application Publication
(10) Pub. No.: US 2022/0128025 A1
(43) Pub. Date: Apr. 28, 2022

(54) SYSTEM FOR ELECTRICITY GENERATION USING HEAT PUMP AND HYDRO TURBINES

(71) Applicants: Kiran Tanaji Tetgure, Pune (IN); Akash Tanaji Tetgure, Pune (IN); Tanaji Rongu Tetgure, Pune (IN)

(72) Inventors: Kiran Tanaji Tetgure, Pune (IN); Akash Tanaji Tetgure, Pune (IN); Tanaji Rongu Tetgure, Pune (IN)

(21) Appl. No.: 17/250,829

(22) PCT Filed: Apr. 24, 2019
(86) PCT No.: PCT/IN2019/050329

§ 371 Date: Mar. 9, 2021

(30) Foreign Application Priority Data
Sep. 10, 2018 (IN) 201821034074

(51) Int. Cl. F03B 17/00; F03B 13/00; H02K 7/18

(52) U.S. Cl. CPC F03B 17/005; F05B 2220/20; H02K 7/1823; F03B 13/00

(57) ABSTRACT

A System for Electricity Generation Using Heat Pump and Hydro Turbine, having very high efficiency is disclosed herein. The said system comprises Circular pipes arranged in rectangular pattern to form close circuit of water (10), water pump (1)attached to first end of said closed circuit (10), heat pump, hydraulic turbines (T1(3), T2(4) and T3(5)) placed at other three corners of the closed circuit (10), heater (2). Present invention uses pressure raised after low temperature heating of water in closed circuit (10) for energy generation. The hydraulic turbines are used to capture pressure generated in the closed circuit (10) and to convert it in mechanical work. As system works on low temperature it avoids huge losses of heat energy occurring at currently available mechanisms. The system is simple in construction, compact, low in capital cost, suitable for operation with local water and over a wide range of climatic conditions.

### FIELD OF THE INVENTION

The present invention generally relates to electricity generation systems. Particularly it relates to system for electricity generation using heat pump and hydro turbines. More particularly the present invention generates electricity using pressure raised due to low temperature heating of water in its liquid state.

### BACKGROUND OF THE INVENTION

Many countries are trying to match with the huge energy demands of their industrial sectors. According to ‘Global Energy Statistical Year book 2018’ published by “Enerdata” overall power consumption of world increased by 2.6% in 2017. It also says that the Electricity consumption globally increases at a faster pace than other energy vectors due to electrification of energy uses.

High economic growth rates and energy consumption go hand in hand, particularly because the industrial sector is often the largest energy-consuming sector in many countries. For highly populous and fast-growing economies like India, China and Africa and also for the developed economies, demand for energy especially in form of electricity will never slow down, so it is needed to have an environmentally friendly, cost and energy efficient technology for the power plant to serve this demand.

Conventional electricity generation plants include thermal power plants, hydro power plants and nuclear power plant etc. Most of these conventional power stations burn fossil fuels such as coal, oil and natural gas for electricity generation. Burning of fossil fuel causes huge production of Carbon-di-oxide (CO2) in the atmosphere. Also, the exhausted gases from power stations harm outside environment badly and ultimately causes rise in the MSL (Mean Sea Level) of ocean water.

The available Thermal power Plants possess various other drawbacks such as:
Higher maintenance and operational costs
Huge requirement of water
Gestation period is a long time
Efficiency of thermal plant is quite less (maximum 40-45%)
Conventional Thermal power plants work at higher temperatures. Due to working at higher temperatures, the thermal losses occur in the plant and the plant components witness process of erosion.
They also work at high pressures which require thicker walled piping thereby the cost of fabrication and cost of maintenance increases. Also, the Thermal engines requires huge amount of expensive lubricating oils.
Without the ejection of heat, it is not possible to convert heat energy into mechanical energy and to drive the turbine without drop in temperature. Therefore, majority of the loss takes place in the condenser; thus, efficiency of the thermal power plant is very poor.

Among the thermodynamic cycles, Organic Rankin Cycle (ORC) is considered to be an effective approach in harnessing low-grade thermal energy. ORC is used in heat recovery of low-temperature sources such as biomass combustion, industrial waste heat, and geothermal heat. The efficient operation of ORC depends on the working fluid and expander employed which determines the efficiency and power output of the cycle.

The design of Organic Rankin Cycle is very similar to that of the Steam Ranking Cycle where the working fluid, water, is replaced by an organic fluid with a much lower boiling point temperature. This replacement allows for the power generation cycle to function at a lower temperature range than what is required to bring water to its superheat temperature in a Steam Rankin Cycle.

Few Patent documents relating disclosed in prior art which work on low temperature are:
1. Patent Document U.S. Pat. No. 8,733,103B2 discloses the A thermal energy conversion plant, wherein a pressurized liquefied working fluid gasifies in an evaporator unit located at the lower level of a closed-loop thermodynamic circuit, ascends through a widening ascending conduit to a condenser unit located at the upper level of said thermodynamic circuit, condenses and fails because gravity powering a power extraction apparatus, before entering back into the evaporator, and restarting the cycle. The said thermal energy conversion plant is located in a floating platform, which has been designed for tropical warm seas, wherein the warm shallow sea water 83 will be the heat source, and the cold deep-sea water 84 will be the heat sink. The working fluid used in this system is heavy molar mass gas or compound, with a high density in its liquefied phase.

This plant is designed to use naturally available heat from sea water. In this plant, the working fluid is heated so that it is converted into vapour and then condensed to a height to gain potential energy. The said potential energy is used to generate power. It is vertical system in which evaporator is located at lower level and condenser is located at higher level. In present invention, the heat is used to generate pressure in water which is then used to generate power. The water is heated by coal or available sources of heating.
2. In patent document EP0082671A2 there is provided a method of converting thermal energy into another energy form, comprising the steps of providing a liquid working fluid with said thermal energy, substantially adiabatically compressing the working fluid, substantially adiabatically expanding the hot compressed working fluid by flashing to yield said other energy form in an expansion machine capable of operating with wet working fluid and of progressively drying said fluid during expansion, and condensing the exhaust working fluid from the expansion machine.
The working fluid used in this system is an organic or suitable inorganic fluid, and is selected from the group including refrigerants 11, 12, 21, 30, 113, 114, 115, toluene, thiophene, n-pentane, pyridene, hexafluorobenzene, FC 75, monochlorobenzene and water. In this method the working fluid is compressed and heated which is then expanded in expansion mechanism to generate power, The method converts liquid working fluid into vapour. Whereas in present invention, only water is used as working fluid; the water is heated to increase its volume without changing its state for generating power.
3. Patent document U.S. Pat. No. 4,306,416A is a closed cycle, hydraulic-turbine heat engine for providing a steady electrical or mechanical power source from any available or created relative heat source comprising an evaporation chamber, a vapor conduit
connected to the evaporation reservoir and extending vertically there from, a condensing reservoir at the upper end of the gas conduit, and a liquid conduit between the condensing reservoir and the evaporation chamber. Though the system is pollution free system which operates on solar or geothermal energy, to generate useful electrical energy; the system is especially adapted to operate as an individual unit for homes or small factories only,
Hence there is need of the System for Electricity Generation using Heat Pump and Hydro turbine which overcomes the problems set forth in prior art.

### OBJECT OF THE INVENTION

The main object of the present invention is to provide A System for Electricity Generation Using Heat Pump and Hydro Turbine, having very high efficiency (up to 90%) in which heat input is taken from external heat source such as heater running on coal or other fuel and/or heat taken from the river water through heat absorber.

Another object of the present invention is to provide A System for Electricity Generation Using Heat Pump and Hydro Turbine which is simple in construction, compact, low in capital cost, suitable for operation with local water and over a wide range of climatic conditions.

Further object of the present invention is to provide A System for Electricity Generation Using Heat Pump and Hydro Turbine which is ecofriendly system, foolproof and durable in operation.

Yet further object of the present invention is to provide A System for Electricity Generation Using Heat Pump and Hydro Turbine which generates the electricity by converting heat pressure into work.

Still another object of the present invention is to provide A System for Electricity Generation Using Heat Pump and Hydro Turbine through lower temperature heating thus avoiding losses and erosion of the components in the system.

### STATEMENT OF THE INVENTION

Accordingly, present invention A System for Electricity Generation using Heat Pump and Hydro Turbine is a power generation system which uses low temperature heated water in its liquid state to generate electricity

The system comprises water pump, pipes arranged in rectangular pattern to form close circuit of water, hydraulic reaction turbines and heat pump. At one end of the said circuit, water pump is provided and at other three ends hydraulic turbines are attached. The water pump is used to feed the water in the system as well as to provide the low velocity to the water in the system. Heat pump cycle to recover the remaining heat from water after passing through all three turbines is included in rectangular closed circuit of pipes containing water. The system generates electricity by converting heat pressure into work.

In one embodiment, the system may use tap water and external heater to generate electricity.

In other embodiment, the system may use river water and heat absorber to generate electricity.

### Working Principal of the Invention

For water in a closed container, an increase in the temperature has a tremendously greater and potentially catastrophic effect. As the fluid temperature increases, it tries to expand, but expansion is prevented by the wall of the container. Because the fluid is incompressible, this results in tremendous increase in pressure for a relatively minor temperature change. The change in specific volume for a given change in temperature is not the same at various beginning temperature.

The water is compressible but very low due to its high density and therefore a small change in volume creates a huge pressure change. The system uses the high pressure generated due to heating of water at low temperature in closed loop to generate electricity. Hydraulic turbines are used in this system so that the heat pressure gets converted into work.

More precisely, the invention focuses on using only water in the system to create pressure by keeping the constant volume of water and completely restrict steam formation to avoid all the deficiencies of currently available technique of electricity generation. The velocity of the water is kept low so the power carrying density is optimum.

Advantages presented by the invention are as follows:
This system of invention recover most of the of unused heat energy by the use of heat pump at the end of the process (after removal of pressure head which is mechanical work) so there are minimum heat losses.
This system of invention works at low temperature (150° C.) and low-pressure range (10 bars to 67 bars). Hence the maintenance cost and the construction cost would be low.
This plant has water as its working fluid so due to its high density it can produce larger work compared to its volume
This plant will reduce fuel consumption by 50% and more.

### BRIEF DESCRIPTION OF THE DRAWINGS

FIG. 1 shows top view of system according to present invention with external heat/thermal source

FIG. 2 shows the solid view of the present invention with external thermal source FIG. 3 shows the isometric view of the present invention with external thermal source

FIG. 4 shows top view of system according to present invention which uses river water and heat absorber for electricity generation

FIG. 5 shows solid top view of the present invention uses river water and heat absorber for electricity generation

FIG. 6 shows the solid isometric view of the present invention uses river water and heat absorber for electricity generation

FIG. 7 shows the top solid view of components of heat pump when external heat/thermal source is used in the system

FIG. 8 shows the isometric solid view of heat pump components when external heat/thermal source is used in the system

FIG. 9 shows top solid view of components of heat pump when no external heat/thermal source is used in the system

FIG. 10 shows the isometric solid view of heat pump components when no external heat/thermal source is used in the system

FIG. 11 shows graphical representation of the entropy in the present invention with external heat source

FIG. 12 shows graphical representation of the entropy in the present invention uses river water and heat absorber for electricity generation

As illustrated in FIG. 1 to FIG. 4, present invention comprises a water pump (1), heat pump, pipes arranged in rectangular pattern to form close circuit of water (10), hydraulic reaction turbines (T1(3), T2(4), T3(5)) placed at three corners/end of the closed circuit. The water pump (1) is attached to last end of the close circuit (10). The evaporator (6), compressor (7), condenser (8) and expansion tube (9) are the components of heat pump. Generators G1, G2 and G3 are attached to turbines T1, T2 and T3 respectively.

In one embodiment, the system may use tap water and external heater (2) to generate electricity in the rectangular shape closed circuit of pipes (10) as shown in FIG. 1 FIG. 2 and FIG. 3.

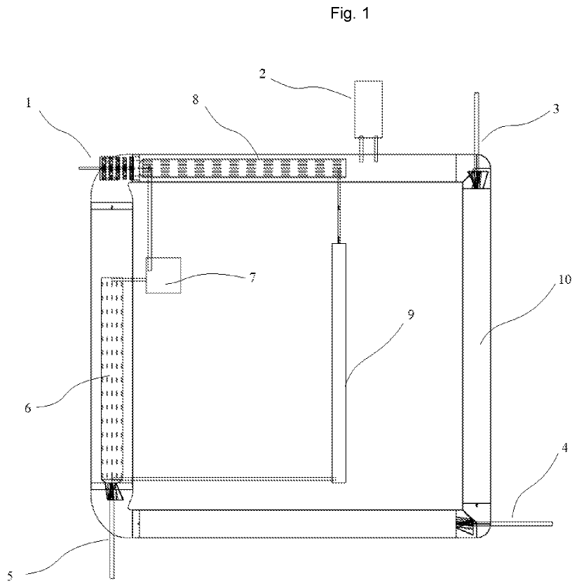

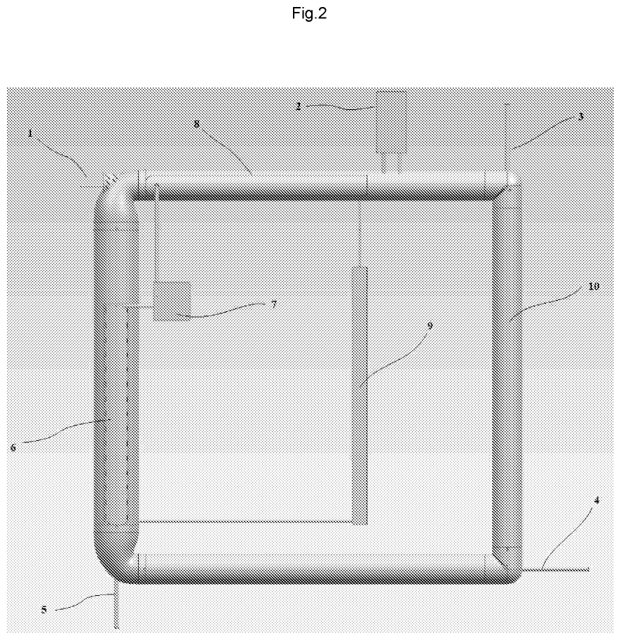

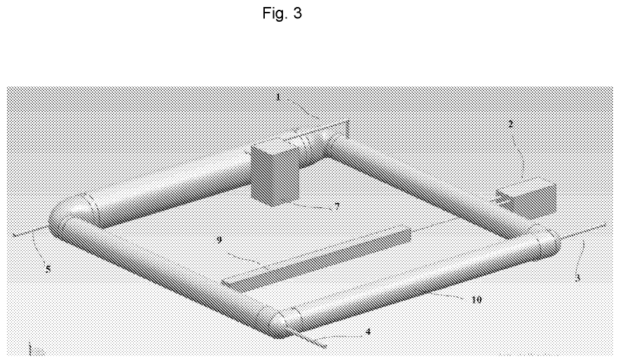

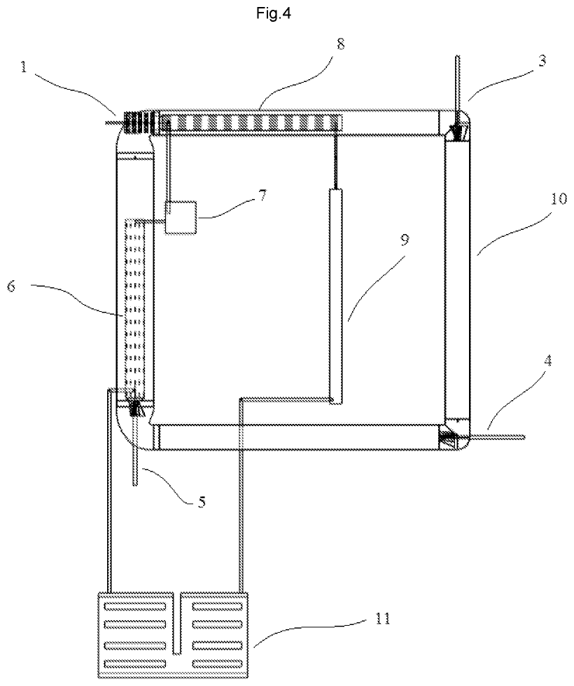

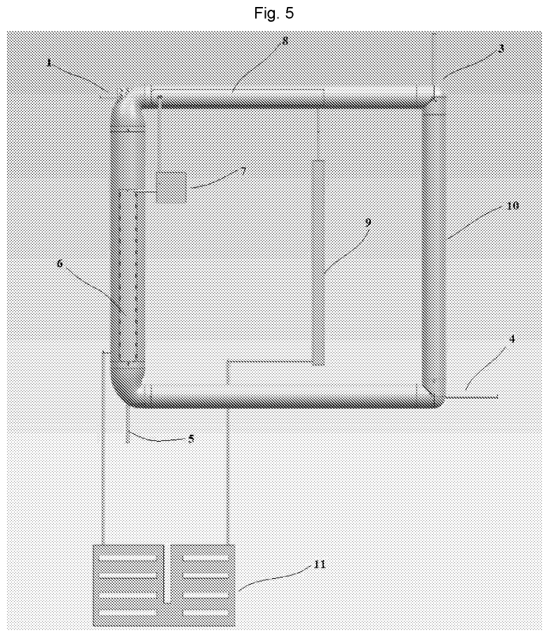

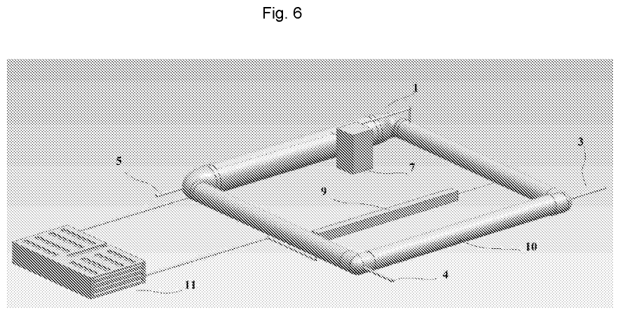

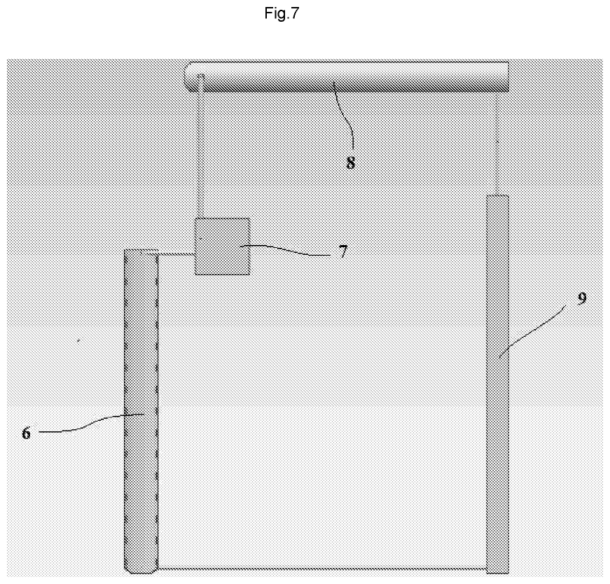

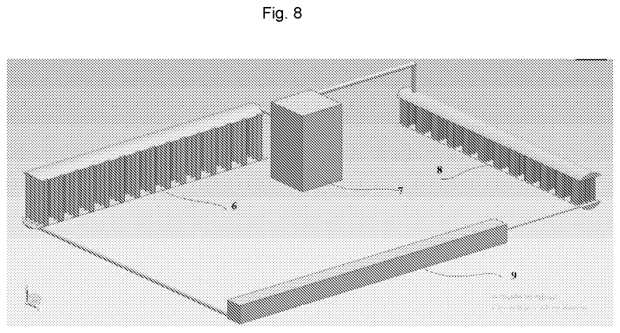

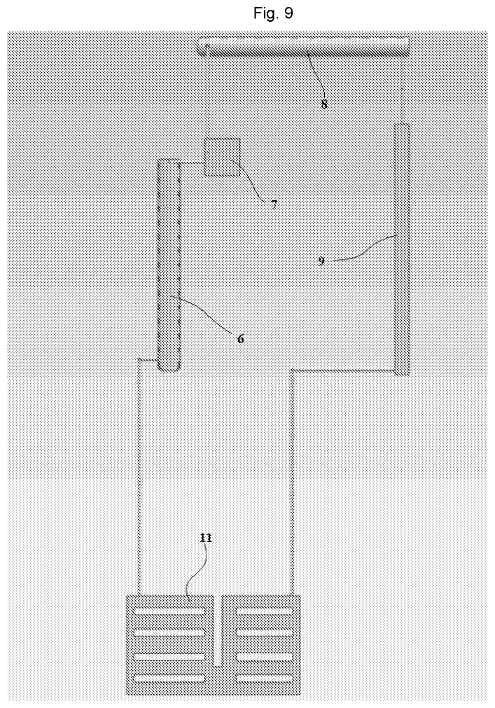

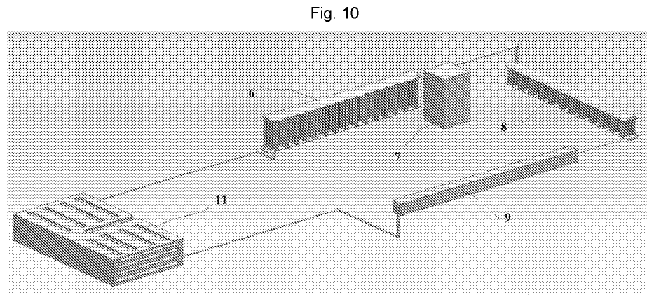

In other embodiment, the system may use river water and heat absorber (11) to generate electricity as shown in FIG. 4, FIG. 5 and FIG. 6. In this case heat pump components are used to remove heat from lake /river water and to recover remaining heat in the closed circuit (10) after water has passed through all three turbines.

### Working of the System

As illustrated in FIG. 1 Water at room temperature is allowed to flow through the closed circuit (10). Heater/Boiler (2) is used to provide thermal energy to water. Or as shown in FIG. 3, Heat absorbed from river water trough heat absorber (11) is used to provide thermal energy to the system in FIG. 4.

The water is heated at low temperature up to 150° C. As the system is closed circuit, water keeps on circulating in the loop and passes through hydraulic turbines T1(3), T2(4) and T3(5). A hydraulic turbine takes water in one direction and gives water out in 90 degree from inlet.

The Heat pump is divided into two parts. The upper section works on the heat recovery system which takes heat from evaporator (6) and other section which provides the heat from heater/boiler (2). The water in the closed circuit (10) is heated by the heater (2). As the heating chamber is completely filled with water, rise in temperature of water leads to increase in volume thereby increase in pressure. The turbines convert the mechanical energy generated due to high pressure condition into the work which is then converted into electricity through generators.

The water in the Heat pump is forced to flow in one direction by pump (1). The power required to pump (1) the water is recovered by the generators as energy given by the pump (1) to water is kinetic or the pressure energy. At the end the kinetic energy gets converted into pressure energy which is absorb by the pressure head of the hydraulic turbines.

Initially as water is not uniformly heated, the first turbine T1(3) absorbs less amount of power from closed circuit (10). After water passes through hydraulic turbine T1(3), heat gets uniformly distributed in the closed circuit (10) due to orderly distribution of water through the turbine's fins. The water now has high pressure due to uniform heating. The second turbine T2(4) absorbs large amount of pressure to generate power. The third turbine T3(5) absorbs the remaining pressure so as to match the inlet pressure of the pump (1). The pressure created due to loss in kinetic energy of water at corners is absorb by the third generator T3(5). The outlet of third turbine T3(5) is connected to evaporator (6) to reuse heat by Heat Pump which is then used for heating by condenser (8). Water vapour is converted to water in the condenser (8) and then that water is fed into the expansion tube (9). In best mode of the system, the water is heated up to 150° C. temperature and 10 bar base pressure. When temperature is rose by 1° C. i.e. when water is heated from 150° C. to 151° C. the system gets maximum increase in pressure i.e. 19 bar which is then absorb by the hydraulic turbines to generate electricity.

Following calculations shows maximum pressure generated through the system when water temperature is increased by 1° C. temperature from 150° C. to 151° C. by way of example:

A. When System Uses External Heat Source and Tap Water:
Case 1: Water of 1 m³ was passed through in closed circuit of pipes and was heated to rose its temperature from 1500 C to 151° C. the total pressure rose was calculated in following ways:

Water at 150° C. has density of 917 Kg/m³, Specific heat is 4.3 KJ/Kg and volume of 0.001091 m³/Kg. Also, its isothermal compressibility is 0.0006204/MPa.

As Bulk Modules=1/compressibility=1611.86 MPa=16118.6 bar

To Calculate volumetric expansion of water after 150° C. for 1° C. rise.

Standard values from Steam Table:

State 1: Pressure=4.8 bar

Temperature=150.31° C.

$$Volume = 0.001091 {m}^{3} / Kg Density = 916.59 {\text{Kg/m}}^{3}$$

State 2: Pressure=5 bar

Temperature=151.84° C. Volume=0.001093 m³ /Kg Density=914.91 Kg/m³

Let consider 1 kg of water so total temperature change and volume change in above state is

$$T 0 = 151.84 - 15031 = 1.53 ° C . \\ V 0 = 0.001093 - 0.001091 = 0.000002 {m}^{3} \\ Therefore , Volume change per degree Celsius = V 0 / T 0 = 0.000002 / 1.53 = 1.307 \times {10}^{- 6} {m}^{3}$$

So volumetric expansion of water after 150° C. for 1° C. rise is 1.307×10⁻⁶ m³/Kg

Hence if the water of 1 m³ was placed in closed circuit and was heated to rise its temperature from 150° C. to 151° C. the total pressure rise was:

$$Rise in Total Volume if allowed to expand = Density \times Expansion per Kg = 917 \times 1.307 \times {10}^{- 6} = 1.1985 \times {10}^{- 3} {m}^{3}$$

$$As bulk modules = ( P 1 - P 0 ) / ( ( V 1 - V 0 ) / V 0 )$$

$$Where P 0 = Initial Pressure$$

$$P 1 = Final Pressure$$

$$V 0 = Initial Volume$$

$$V 1 = Final Pressure$$

Hence here the volume taken is 1 m³, therefore V0=1 m³

V1−V0 is the total volume change.

Here considers the initial pressure is 5 bar, therefore P0=5 bar P1−P0 is the total pressure rise.

The Bulk modules is found to be 16118.6 bar

Therefore, 16118.6=Pressure rise/1.1985×10⁻³

Pressure rise=19.31 bar

That's is approximately 19 bars
Case 2: Supply total heat to the 5 Kg of water instead of total water in the 1 m³

The specific heat of water at 150° C. is 4.3 KJ /Kg. Therefore, for 1 m³ of water to get 1° C. rise the total heat required is Q=4.3×Density=4.3×917=3943.1 KJ

Supply total heat to the 5 Kg of water instead of total water in the 1 m³ So heat given to each Kg of water is

$$Q 0 = 3943.1 / 5 = 788.62 KJ$$

The Enthalpy of water at 150° C. is 633.5 KJ/Kg (H1)

Hence the total resultant Enthalpy is

$$H = H 1 + Q 0 = 633.5 + 788.62 = 1422.12 KJ$$

The Properties of water with 1422.12 KJ/Kg according to the steam table are 103.37 bar, 313.267° C. and volume 0.00146546 m³ /Kg.

$$Total Volume Increase = 5 Kg \times ( 0.00146546 - 0.001091 ) = 1.8723 \times {10}^{- 3}$$

Hence the pressure rise will be

$$P = Total Volume Increase X Bulk Modules = 1.8723 \times {10}^{- 3} \times 16118.6 = 30.17 bar$$

Hence the Approximate Pressure rise is 30 bars. In Case 1, pressure head has 19 bar pressure In Case 2, pressure head has 30 bar pressure.

The 1 bar pressure head for 1 m³ of water gives power as 11.11 m depth gives 1 bar pressure at 917 Kg/m³ density

Therefore

For 1 bar Pressure head, Power=mass*gravitational acceleration*height=917×9.81×11.11=99943.0 J=99.94 KJ

Hence the Approximate Power is 100 KJ

$$Therefore , in Case 1 Power Generated = Total Pressure Head X Power per head = 19 \times 100 KJ = 1900 KJ = 1.9 {\text{MJ/m}}^{3}$$

$$In case 2 Power Generated = Total Pressure Head X Power per head = 30 \times 100 KJ = 3 {\text{MJ/m}}^{3}$$

$$Total heat input for 1 {m}^{3} is Q = Specific heat \times Total mass = 4.3 \times 917 = 3.9 {\text{MJ/m}}^{3}$$

Therefore, efficiency of the system is derived as

$$Case 1 = 1.9 / 3.9 = 48.7 \%$$

$$Case 2 = 3 / 3.9 = 76.92 \%$$

Heat Pump Calculations

Remaining heat can be recovered by the heat pump

The heat pump with water as working fluid has a COP of 7

So small part of output power can be used to run a heat pump to recover total heat, therefore overall efficiency of thermal power plant in both cases is 100%.

The heat pump will work in the range of 123.27° C. to 175° C. so as shown in

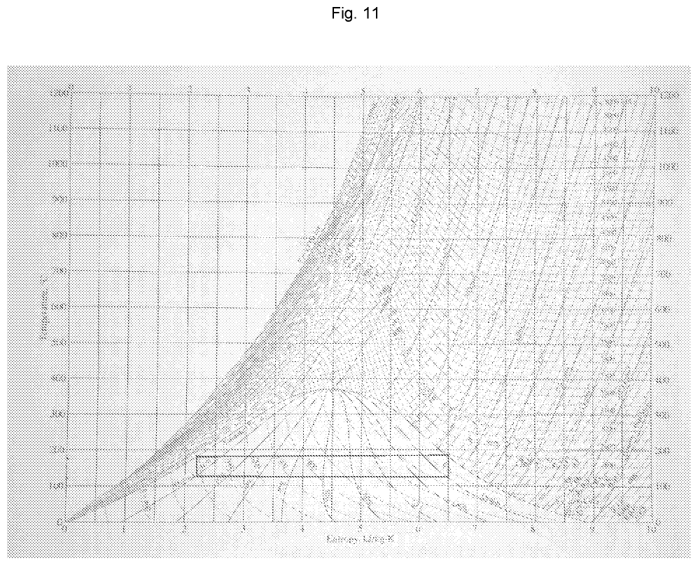

FIG. 11 From the T-s Diagram for water, it is found out that

$$H 1 enthalpy before compression = 2491.3 \text{KJ/Kg} — ( Vapour ( 90 \% ) + Liquid ( 10 \% ) at 123.27 ° C . at 2.1 bar ) \\ H 2 enthalpy after compression = 2772.1 \text{KJ/Kg} — ( Vapour at 175 ° C . ) \\ H 3 enthalpy after condensation of condenser = 2772.1 \text{KJ/Kg} — ( Liquid at 175 ° C . at 9 bar ) \\ H 4 enthalpy after expansion = H 3 — ( Liquid ( 90 \% ) + Vapour ( 10 \% ) at 123.27 ° C . ) \\ COP of heat pump is = H 2 - H 3 / H 2 - H 1 = ( 2772.1 - 742.6 ) / ( 2772.1 - 2491.3 ) = 2029.5 / 280.8 = 7.2 COP$$

Hence the Approximate COP is 7 For system with 100 MW plant
(1) Condenser converts 40% of heat to work (pressure).—(Case 1)
(2) Boiler/heater converts 50% of heat to work (pressure).—(Case 2)

B. When River Water and Heat Absorber (11) is Used in System for Electricity Generation.

In this design the heat is not given by external heat source but it is taken from the water of nearby lake or river. Heat absorber (11) has water of 7° C. which absorbs heat from river (lake) and converts some part of 7° C. water to 7° C. of vapour. Then the heat absorber absorbs remaining unused heat from system which is 152° C. water at 10 bar and converts in to 150° C. which is then pass to pump to initial cycle. The water in evaporator is now at 123° C. vapour from 7° C. water and is now pass to compressor.

### Heat Pump Calculations

Remaining heat can be recovered by the heat pump

The heat pump with water as working fluid has a COP of 7

The heat pump will work in the range of 7° C. to 175° C. so as shown in

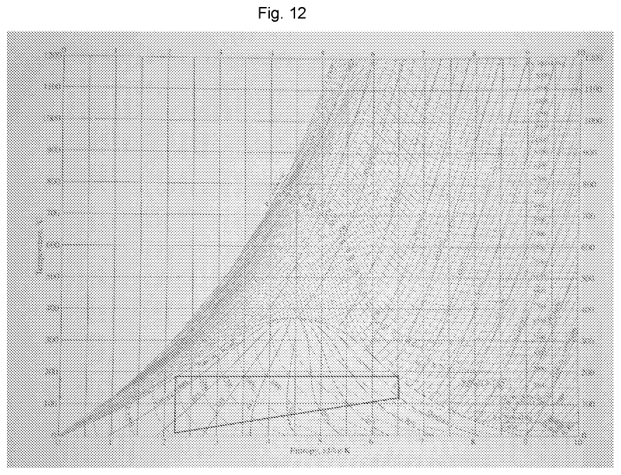

FIG. 12, From the T-s Diagram for water, we found out that

$$H 1 enthalpy before compression = 2491.3 \text{KJ/Kg} — ( Vapour ( 90 \% ) + Liquid ( 10 \% ) at 123.27 ° C . at 2.1 bar ) \\ H 2 enthalpy after compression = 2772.1 \text{KJ/Kg} — ( Vapour at 175 ° C . ) \\ H 3 enthalpy after condensation of condenser = 2772.1 \text{KJ/Kg} — ( Liquid at 175 ° C . at 9 bar ) \\ H 4 enthalpy after expansion = H 3 — ( Liquid ( 90 \% ) + Vapour ( 10 \% ) at 123.27 ° C . ) \\ COP of heat pump is = H 2 - H 3 / H 2 - H 1 = ( 2772.1 - 742.6 ) / ( 2772.1 - 2491.3 ) = 2029.5 / 280.8 = 7.2 COP$$

Hence the Approximate COP is 7

### Best Mode of the System:

To generate electricity of 100MW where heat in system is provided through heater (2):

System specifications:
1. Closed circuit of pipes (10):
   Length of all pipes: 100 m, Diameter of first pipe: 6 m, Diameter of remaining three pipes: 4 m
2. Water pump (1) attached to the first end of closed circuit
3. Heater (2) with 100 MW heating capacity
4. Three Francis turbines (T1(3), T2(4), and (T3(5)) attached at three corners of the closed circuit
5. Heat Pump components such as evaporator (6), condenser (8), compressor (7) and expansion tube (9).

Water which was at room temperature was passed through rectangular closed circuit of pipes (10). To provide velocity and one directional flow for water in system, pump (1) was used. Volume flow rate in system was 25.64 m³/s and water pass at velocity of 2.04 m/s through 4 m diameter pipes. Heater (2) was used to provide heat input to the closed circuit (10).

Water was heated to up to 150° C. by the heater (2). Once the temperature is at 150 ° C. now we can heat the water in boiler (heater) in two different ways

Case-1. We can heat water uniformly (by 1° C. rise) to generate pressure about 19 bar

$$( Total pressure = 19 + 10 = 29 bar )$$

Case-2. We can heat small amount of water, e.g. 5 Kg of water per 1 m³ volume. Which generates greater expansion and also greater pressure about 35 bar

$$( Total pressure = 35 + 10 = 45 bar )$$

This pressure developed in the system by Case-2 is 16 bar more than Case-1. So, the 16-bar work is need to be use by turbine (1) to generate work. Because after passing through turbine (1) the water will get uniformly heated and get convert to Case-1.

The remaining work of 19 bar will be converted in to work by turbine (2). So, the remaining heat in water and base pressure of 10 bar is present in water is than pass to evaporator.

To remove pressure generated in the closed circuit (10) and to convert it in to mechanical work (for generating electricity) three Francis turbines were used in the system. When water was heated from 150° C. to 151° C. in water state in closed circuit (10), the pressure exerted by the water was 19 bar. The pressure generated by the heated water was absorbed by the hydraulic turbines to generate electricity. The outlet of third turbine T3(5) was connected to evaporator (6) to reuse heat by Heat Pump; further this heat was used by condenser (8) for heating. Water vapours were converted to water in the condenser (8) and then that water was fed into expansion tube (9). Thus, Heat pump cycle continued along with the main cycle of the closed circuit (10) to generate electricity by heating water at very low temperature.

### Calculations for Heat Pump Cycle in Above System:

1. Evaporator—123° C. water is flowing through it which absorbs remaining heat from water in closed circuit which was not use by the circuit; this unused water gets converted in to 123° C. vapour.

The length of evaporator is 100 m and width is 4 m and 4.2 m height

It has heat 200 plates along the length and 100 plates along width. Total 20,000 plates.

Each plate has 0.2 m length, 4 m height and 1.6 cm thick. With 1 cm hollow space in it to allow refrigerant water at 123° C. to flow.

$$Total heat area of plates is = 2 * 4 * 0.2 * 20000 = 32000 {m}^{2}$$

$$Total heat transfer = 340 * 25 * 32000 = 270 MW$$

(Where 340 W/m² ° C. is overall heat transfer coefficient for Water-Mild Steel-Water in contact and 25° C. is temperature difference)

Heat absorb by evaporator was 176 MW

2. Compressor—converts the 123° C. vapour in to 175° C. vapour by use of mechanical power. The mechanical input to the compressor is 34 MW. The flow rate of refrigerant is 0.1199 m³/s or (110 kg/sec). The diameter of pipe for refrigerant is 0.5 m and 0.61 m/s velocity.

3. Condenser—Has 175° C. vapour flowing through it which gives heat to water which is use to generate pressure and converted in to 175° C. water.

The heat given by condenser is 210 MW

The length of condenser is 100 m and width of 2.8 m and 3 m height

It has heat 300 plates along the length and 100 plates along width. Total 30,000 plates

Each plate has 0.2 m length, 2.8 m height and 1.6 cm thick. With 1 cm hollow space in it to allow refrigerant vapour at 175° C. to flow.

$$Total heat area of plates is = 2 * 2.8 * 0.2 * 300000 = 33600 {m}^{2}$$

$$Total heat transfer = 340 * 25 * 33600 = 285 MW$$

4. Expansion tube—The expansion tube reduces pressure of 175° C. water and boils till it drop its temperature to 123° C. water and some vapour. The diameter of this expansion tube is 0.

We claim:

1. A System for Electricity Generation Using Heat Pump and Hydro Turbine comprising:
Circular pipes arranged in rectangular pattern to form close circuit of water (10);
water pump (1)attached to first end of said closed circuit (10),
heat pump;
hydraulic turbines (T1(3), T2(4) and T3(5)) placed at three corners of the closed circuit (10);
characterized in that to generate electricity, said system uses pressure raised, by low temperature heating of water in its liquid state in closed circuit (10)

2. The System for Electricity Generation Using Heat Pump and Hydro Turbine as claimed in claim 1 wherein for water heating system uses heat sourse.

3. The System for Electricity Generation Using Heat Pump and Hydro Turbine as claimed in claim 2 wherein the heat source used is external heater (2)

4. The System for Electricity Generation Using Heat Pump and Hydro Turbine as claimed in claim 2 wherein the heat absorbed by the heat absorber (11) from river water is used as heat source for the system

5. The System for Electricity Generation Using Heat Pump and Hydro Turbine as claimed in claim 1 wherein the ratio of cross-section area of the first pipe to other three pipes is 2:1

6. The System for Electricity Generation Using Heat Pump and Hydro Turbine as claimed in claim 1 wherein:
the system uses Heat pump cycle to recover the remaining heat in closed circuit (10) after the pressure energy generated in the said circuit has been used by all three turbines;
the evaporator (6), conderser (8), compressor (7) and expansion tube (9) are the componets of heat pump;

7. The System for Electricity Generation Using Heat Pump and Hydro Turbine as claimed in claim 1 wherein the water pump is used to
feed the water in the system;
to provide the one directional low velocity to the water in the system

8. The System for Electricity Generation Using Heat Pump and Hydro Turbine as claimed in claim 1 wherein hydralic turbines T1(3), T2(4) and T3(5) convert the mechanical energy generated due to high pressure condition into the work which is then converted into electricity through generators G1, G2 and G3 respectively.

9. The System for Electricity Generation Using Heat Pump and Hydro Turbine as claimed in claim 8 wherein the hydraulic turbines used in the system is water reaction turbine

10. The System for Electricity Generation Using Heat Pump and Hydro Turbine as claimed in claim 4 wherein the heat absorber (11) is used to absorb the heat from water taken from natural source such as river, lake etc. and no heater (2) is used to provide thermal energy to the system
